(19) United States
(12) Patent Application Publication
(10) Pub. No.: US 2007/0030243 A1
(43) Pub. Date: Feb. 8, 2007

(54) Display device and control method for the same

(75) Inventor: Junichiro Ishii, Matsumoto-shi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/497,256

(22) Filed: Aug. 2, 2006

(30) Foreign Application Priority Data
Aug. 4, 2005 (JP) JP 2005-226774

(51) Int. Cl. G09G 3/34

(52) U.S. Cl. 345/107

(57) ABSTRACT

A display device has an electrophoretic display panel for displaying information, and an operating mode switching unit for changing between a normal mode in which information displayed on the electrophoretic display panel is redrawn at a predetermined redraw interval, and a reduced operation mode in which redrawing the electrophoretic display panel is stopped or the redraw interval is increased. The operating mode switching unit redraws a predetermined display area of the electrophoretic display panel to substantially the same color when changing to the reduced operation mode.

### BACKGROUND OF THE INVENTION

1. Field of Technology

The present invention relates to technology for avoiding misalignment of displayed colors in an electrophoretic display panel having an image retention characteristic.

2. Description of Related Art

Japanese Unexamined Patent Appl. Pub. H1-86116 teaches a display device comprising an electrophoretic display panel that operates using electrophoresis, a phenomenon whereby charged particles dispersed in a fluid migrate when an electric field is applied. Such display devices have an image retention characteristic that causes the display content to remain displayed even when power is not supplied, and can therefore continue to display information even when the display is not driven.

One method of extending the battery life in such display devices is to reduce power consumption by reducing the frequency at which the display panel is redrawn. Due to limitations imposed by the specifications of the display device (such as when the display device is used in a timepiece), however, lowering the redraw frequency of the display panel below a certain level is difficult, and the desired battery life therefore cannot be assured. One means of extending the battery life in such situations is to provide a sleep mode (a reduced operation mode) that lowers the redraw frequency of the display panel in specific conditions.

A problem with electrophoretic display panels, however, is that changing the displayed color becomes difficult after any particular color is continuously displayed for a long period of time. If a white display area and a blue display area are held continuously displayed for a long time (such as one hour) on a two-color electrophoretic display panel that displays white and blue, for example, and both display areas are then driven to display white, the display area that was white before the display is redrawn displays a clear white, but the display area that was blue before the display is redrawn turns a slightly dark white.

As a result, if both white and blue are displayed before the sleep mode is entered and the display is redrawn so that the same color is displayed in both display areas after the normal operating mode is resumed, the displayed colors will be misaligned. When display areas of different colors are adjacent when the sleep mode is entered, the colors of the adjacent display areas in particular become misaligned when the normal mode is resumed, and the border between these areas is particularly obvious.

### SUMMARY OF THE INVENTION

An object of the present invention is therefore to provide a display device and a display device control method that can avoid misalignment of the displayed colors when switching from a reduced operation mode in which the redraw frequency of the display panel is reduced to a normal mode and an image is then displayed.

To achieve this object, a display device according to a preferred aspect of the invention has an electrophoretic display panel for displaying information, and an operating mode switching unit for changing between a normal mode in which information displayed on the electrophoretic display panel is redrawn at a predetermined redraw interval, and a reduced operation mode in which redrawing the electrophoretic display panel is stopped or the redraw interval is increased. When changing to the reduced operation mode, the operating mode switching unit redraws a predetermined display area of the electrophoretic display panel to substantially the same color.

By thus redrawing a predetermined display area of the electrophoretic display panel to substantially the same color when changing to the reduced operation mode, misalignment of the display colors can be avoided when resuming the normal mode and displaying an image on the electrophoretic display panel.

Preferably, the predetermined display area is the entire display area of the electrophoretic display panel, or is a display area where an image of substantially the same color is displayed when entering the normal mode. This avoids misalignment of the display colors in the entire display area of the electrophoretic display panel or a display area where an image of substantially the same color is displayed when entering the normal mode.

Yet further preferably, the electrophoretic display panel is a segment display panel, and when entering the reduced operation mode, the operating mode switching unit redraws a portion of the display area of the electrophoretic display panel to substantially the same color in display area units delineated by segments for displaying a background. This avoids misalignment of the text color and the background color when entering the normal mode.

Further preferably, when entering the reduced operation mode, the operating mode switching unit redraws the predetermined display area to substantially the same color as the color to be displayed when the normal mode is entered. This enables accurately displaying the expected color in the predetermined display area when entering the normal mode.

Further preferably, when entering the reduced operation mode the operating mode switching unit displays a substantially monochrome gradation image in the predetermined display area. This reduces color misalignment when entering the normal mode.

Further preferably, when entering the reduced operation mode, the operating mode switching unit redraws the predetermined display area so that at least one of the hue, brightness, and chroma levels is substantially the same. This reduces color misalignment when entering the normal mode.

Further preferably, the display device is rendered as a timepiece having a timekeeping unit for keeping time and displays time information kept by the timekeeping unit. This arrangement affords a timepiece that enters a sleep mode to increase the redraw interval of the electrophoretic display panel and assure sufficient battery life even when using a small battery with low capacity, and can display images without misalignment of the display colors on the electrophoretic display panel when the normal mode is resumed.

Another aspect of the invention is a control method for a display device having an electrophoretic display panel and displaying information on the electrophoretic display panel, the control method comprising a step of redrawing a predetermined display area of the electrophoretic display panel to substantially the same color when changing from a normal mode in which information displayed on the electrophoretic display panel is redrawn at a predetermined redraw interval to a reduced operation mode in which redrawing the electrophoretic display panel is stopped or the redraw interval is increased.

By thus redrawing a predetermined display area of the electrophoretic display panel to substantially the same color when changing to the reduced operation mode, misalignment of the display colors can be avoided when resuming the normal mode and displaying an image on the electrophoretic display panel.

Preferably, when entering the reduced operation mode, a portion of the display area of the electrophoretic display panel is redrawn to substantially the same color in display area units delineated by segments for displaying a background. This avoids misalignment of the text color and the background color when entering the normal mode.

Further preferably, when entering the reduced operation mode the predetermined display area is redrawn to substantially the same color as the color to be displayed when the normal mode is entered. This enables accurately displaying the expected color in the predetermined display area when entering the normal mode.

Further preferably, when entering the reduced operation mode a substantially monochrome gradation image is displayed in the predetermined display area. This reduces color misalignment when entering the normal mode.

Further preferably, when entering the reduced operation mode [the operating mode switching unit redraws, sic?] the predetermined display area <? is redrawn ?> so that at least one of the hue, brightness, and chroma levels is substantially the same. This reduces color misalignment when entering the normal mode.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a plan view of a wristwatch according to a preferred embodiment of the invention.

FIG. 2 describes the display panel of this wristwatch.

FIG. 3 is a schematic section view of the time display unit in the wristwatch.

FIG. 4 is a section view showing the arrangement of the display panel.

FIG. 5 is a block diagram showing the electrical arrangement of the time display unit.

FIG. 6 is a timing chart of the display control operation in the normal mode.

FIG. 7 is a timing chart of the display control operation in the sleep mode.

FIG. 8 describes the display panel of a wristwatch according to a second embodiment of the invention.

### DESCRIPTION OF THE PREFERRED EMBODIMENTS

A preferred embodiment of the present invention is described below with reference to the accompanying figures.

First Embodiment

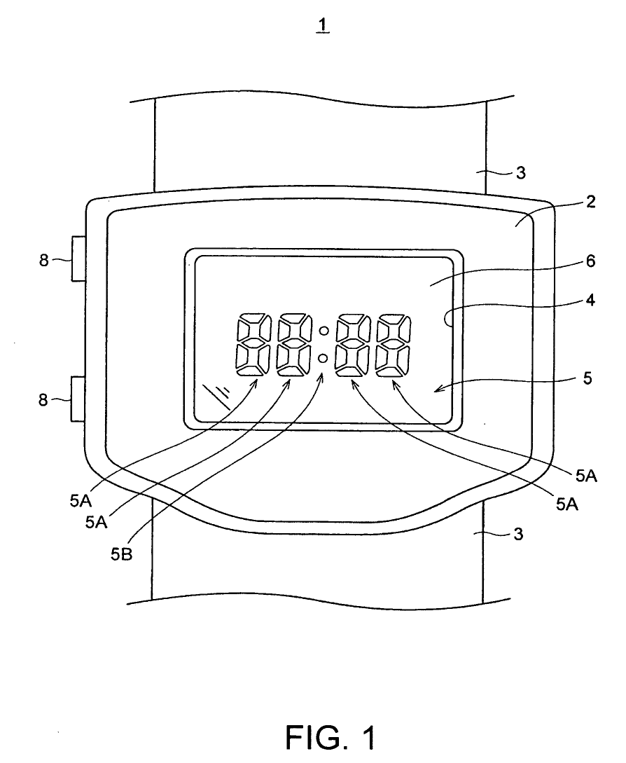

FIG. 1 shows the appearance of a wristwatch 1 according to this embodiment of the invention. As shown in the figure, the wristwatch 1 has a watch case 2, and a wrist band 3 that is attached to the watch case 2 and used to hold the wristwatch 1 on the user's wrist. A time display window 4 for displaying the time is formed in the front of the watch case 2 so that the display panel 5 that displays the time, for example, can be seen through the time display window 4. A crystal 6 made from transparent plastic or transparent glass, for example, is fit into the time display window 4, and the display panel 5 is protected by this crystal 6. Operating buttons 8 for setting the time, changing the operating mode, and performing other operations are also disposed to the watch case 2.

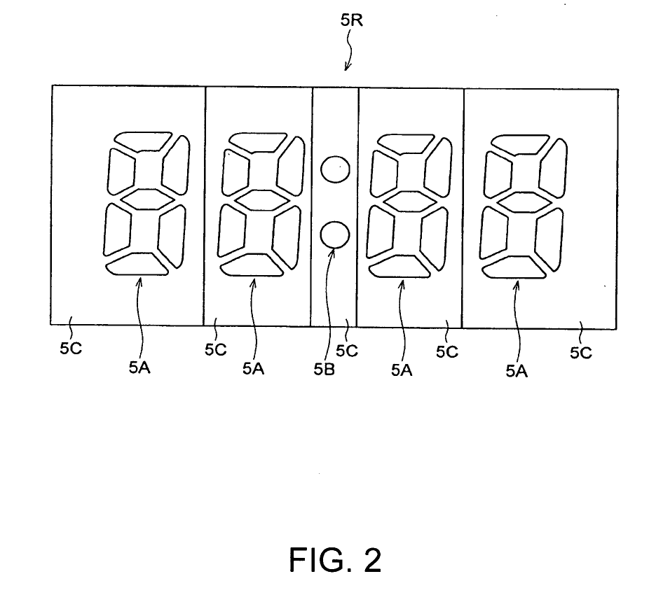

The display panel 5 is a segment display panel for displaying information using a plurality of segments, and functions as a display unit for displaying image information. As shown in FIG. 2, the display area 5R of this display panel 5 comprises four segments (so-called “seven-segment displays”) 5A for displaying the numbers 0 to 9. The left two segments 5A display the hour of the time, and the right two segments 5A display the minute. A segment 5B comprising two circles for displaying a symbol (a colon in this example) separating the hour and minute is located between the hour segments 5A and the minute segments 5A.

As also shown in the same figure, a background segment 5C for displaying a background is also disposed to each of the segments 5A and 5B, and a background (a background of white or blue) is displayed by these background segments 5C for each character (number or colon) displayed by the segments 5A and 5B. An electrophoretic display panel is used for the display panel 5 in this embodiment of the invention, and the construction of the display panel is further described in detail below. Segments 5A to 5C are referred to as segments 5X below when differentiating these segments 5A to 5C is not necessary.

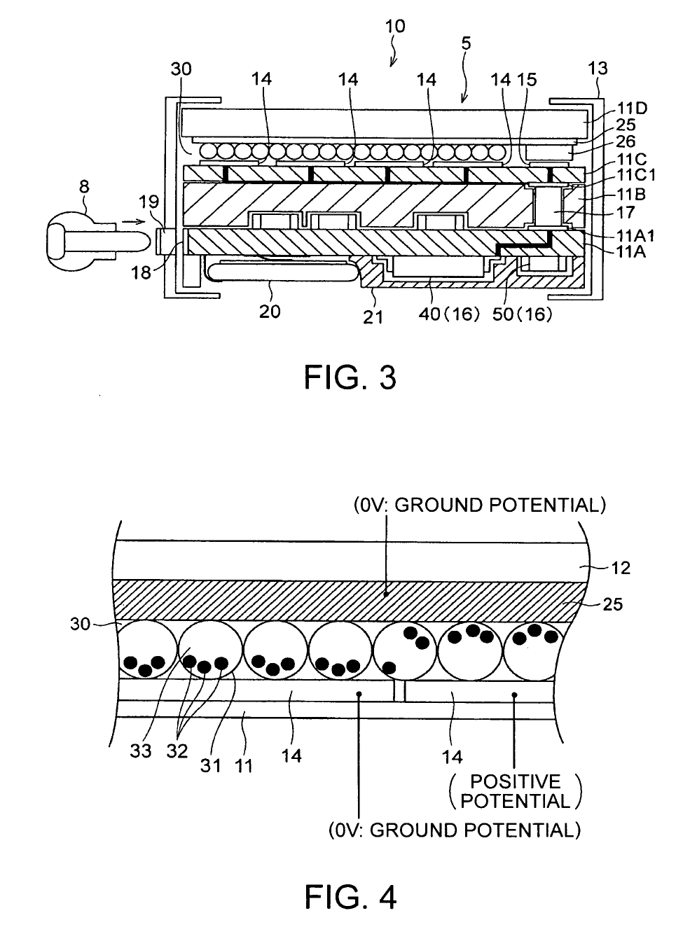

A time display unit 10 rendered in unison with the display panel 5 is disposed inside the watch case 2. As shown in the section view in FIG. 3, this time display unit 10 comprises a circuit board 11A, a display frame 11B, a display substrate 11C, a transparent substrate 11D, and a circuit retainer 13 for holding these other parts.

Segment electrodes 14 for each of the segments 5A to 5C, and a segment electrode 15 for a common electrode, are disposed on top of the display substrate 11C.

The circuit board 11A is on the bottom of the display substrate 11C with the display frame 11B therebetween, and devices 16 rendering the display drive circuit 40 and control unit 50, for example, are mounted on the circuit board 11A. A node 11A1 wired to device 16 (display drive circuit 40) is disposed on top of the circuit board 11A, a node 11C1 wired to the electrodes 14 and 15 is disposed on the bottom of the circuit board 11A, and these nodes 11A1 and 11C1 are electrically connected by a connector 17 passing through the display frame 11B.

A switch electrode 18 is disposed on the side of the circuit board 11A so that conductivity can be established by means of a flat spring 19 disposed to the circuit retainer 13. When the flat spring 19 is deformed as a result of depressing an operating button 8, conductivity is established through the flat spring 19 and the switch closes. Another device 16 (control unit 50 in this embodiment) detects whether the switch is closed or open.

A battery 20 (power supply) for supplying drive power to the devices 16 is removably installed on the bottom of the circuit board 11A. A circuit housing 21 covering the devices 16 is affixed to the circuit board 11A, and the devices 16 are thus protected by the circuit housing 21. A button battery, that is, a primary cell, is used for the battery 20 but the invention is not so limited and a secondary battery can be used instead.

A transparent common electrode 25 formed by ITO (indium tin oxide) vapor deposition, for example, is rendered on the display substrate 11C side of the transparent substrate 11D. An electrophoretic layer 30 is disposed between this transparent common electrode 25 and the segment electrodes 14 of the display substrate 11C, and a common electrode conductor 26 is disposed between the transparent common electrode 25 and the common segment electrode 15. This common electrode conductor 26 is made of a conductive rubber, for example, so that the conductive rubber is deformed according to the gap between the common electrode 25 and the common segment electrode 15 to assure a reliable connection between these electrodes 25 and 15.

As shown in FIG. 4, the electrophoretic layer 30 comprises a multitude of microcapsules 31, and the microcapsules 31 are filled with an electrophoretic dispersion fluid 33 containing electrophoretic particles 32. The electrophoretic particles 32 are, for example, positively charged blue particles and the electrophoretic dispersion fluid 33 is colored white, rendering a so-called one-particle electrophoretic layer.

When the display drive circuit 40 holds the common segment electrode 15 (FIG. 3) at 0 V (ground potential) and supplies a positive drive voltage causing a particular segment electrode 14 to go to a positive potential, an electric field is created from the segment electrode 14 to the common electrode 25. This field causes the positively charged electrophoretic particles 32 (blue particle) inside the microcapsules 31 to move to the common electrode 25 side, and causes the white electrophoretic dispersion fluid 33 to move to the segment electrode 14 side. The microcapsules 31 visible from the transparent substrate 11D side appear blue, and the segments 5X therefore display blue.

Conversely, when the display drive circuit 40 supplies a positive drive voltage to the common segment electrode 15 so that the common electrode 25 is positively charged and holds a particular segment electrode 14 at 0 V, the positively charged electrophoretic particles 32 (blue particle) move to the segment electrode 14 side, and the white electrophoretic dispersion fluid 33 therefore moves to the common electrode 25 side. The microcapsules 31 visible from the transparent substrate 11D side therefore display white, and the segments 5X display white.

If a potential difference is not created between the common electrode 25 and segment electrode 14, the electrophoretic particles (blue particles) 32 do not move, the display color of the segments 5X therefore does not change, and the previous display state is retained.

In this embodiment of the invention the display drive circuit 40 has an internal booster circuit to boost the voltage (such as 3 V) supplied from the battery 20 to produce a +12 V voltage, and supplies this +12 V voltage or 0 V as the drive voltage to the segment electrodes 14 and common electrode 25.

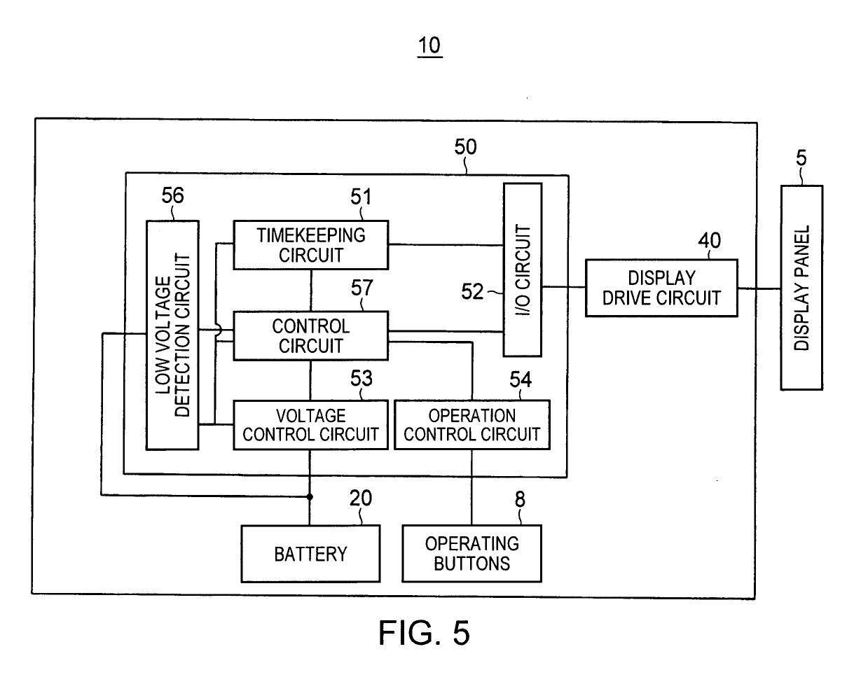

FIG. 5 shows the electrical arrangement of the time display unit 10.

A control unit 50 is electrically connected to the display drive circuit 40 and the battery 20 through an intervening wiring pattern rendered on the circuit board 11A, and comprises a timekeeping circuit 51, input/output (I/O) circuit 52, voltage control circuit 53, operation control circuit 54, low voltage detection circuit 56, and control circuit 57 that functions as an operating mode switching unit.

The timekeeping circuit 51 functions as a timekeeping unit for keeping the time by counting oscillation pulses from an oscillation circuit not shown. The timekeeping circuit 51 is connected to the display drive circuit 40 through the I/O circuit 52.

The voltage control circuit 53 supplies power from the battery 20 to the internal parts of the control unit 50 and the display drive circuit 40. The operation control circuit 54 detects operation of the operating buttons 8 by detecting whether the switch electrode 18 is conductive or nonconductive, and reports the result to the control circuit 57.

The low voltage detection circuit 56 detects the voltage of the battery 20, determines if the battery voltage is less than a minimum threshold level, and reports the result of this determination to the control circuit 57.

The control circuit 57 centrally controls overall operation of the time display unit 10, and comprises a CPU, ROM, and RAM, for example. The CPU runs a control program stored in ROM to control operation of the parts of the control unit 50, and outputs commands to the display drive circuit 40 through the I/O circuit 52.

As described above, the display drive circuit 40 is a circuit for driving the display panel 5 and is controlled by the control circuit 57 to get the time information kept by the timekeeping circuit 51, redraw the display panel 5 at the specified redraw interval, and display the time on the display panel 5.

The control circuit 57 has a function for switching the operating mode of the wristwatch 1 between a normal mode (equivalent to a time display mode) in which the time information displayed on the display panel 5 is redrawn at the update interval of the time (at one minute intervals in this embodiment), and a sleep mode (reduced operation mode) in which the redraw interval of the display panel 5 is longer than the update interval of the time.

The operating mode changes in three possible cases: (1) based on user operation, such as when the operating mode is manually changed by a predetermined operation (such as a short push or a long push) of a predetermined operating button 8; (2) when a preset switching interval is reached, such as causing the sleep mode to be entered at 1:00 a.m. and the normal mode to be resumed at 6:00 a.m.; and (3) based on the remaining battery capacity, such as entering the reduced operation mode when the battery voltage detected by the low voltage detection circuit 56 goes below a minimum threshold level, and the normal mode to be resumed when the battery voltage rises above an upper threshold level (which can be the same as the lower threshold level), and at least one of these is preset.

When the operating mode is set to the sleep mode in the first case (1) and a specific operation of the operating button 8 is detected, the normal mode is enabled for a predetermined time and the current time is displayed on the display panel 5.

Operation in the normal mode is described next.

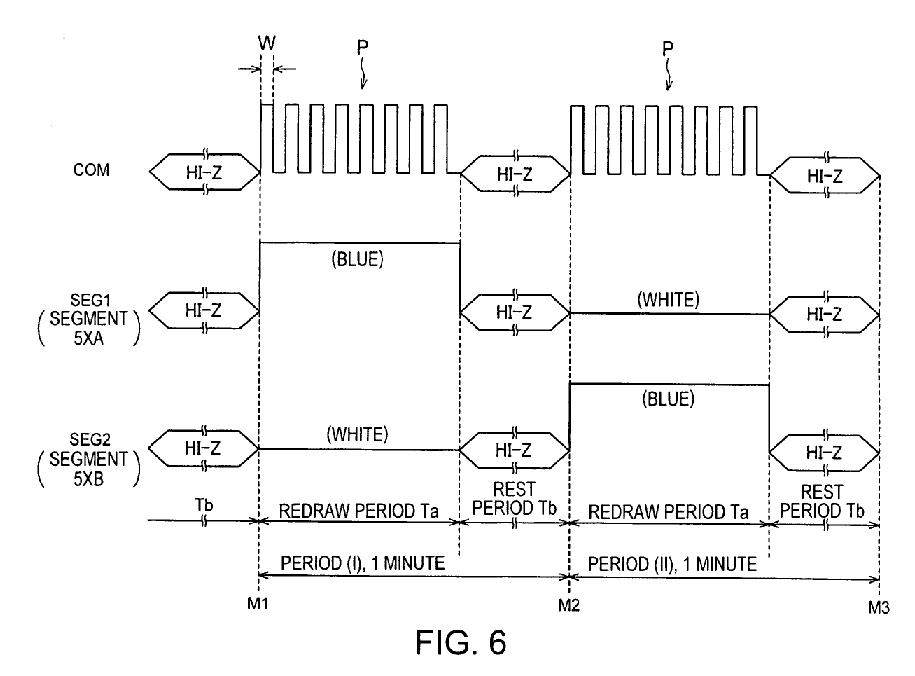

FIG. 6 is a timing chart of the display control operation when in the normal mode. In this figure the control circuit 57 outputs a display switching signal at time M1, and M2 and M3 respectively denote one minute and two minutes after M1. More specifically, the control circuit 57 outputs a display switching signal at times M2 and M3 to the display drive circuit 40. Also shown in the figure are the drive voltage COM supplied to the common electrode 25, and the drive voltages SEG1 and SEG2 supplied to two segment electrodes 14. Note that drive voltage SEG is used below when differentiating the voltage supplied to the segment electrodes 14 is not necessary. This display operation is described as switching the display color of one of two segments 5X from blue to white and switching the display color of the other segment 5X from white to blue, and to differentiate these segments 5X the former is denoted segment 5XA and the latter is denoted segment 5XB.

As shown in the figure, a redraw period Ta and a rest period Tb are provided in the period between when one display switching signal is input to the display drive circuit 40 and the next display switching signal is input. The redraw period Ta is the period in which the displayed time is changed by the display drive circuit 40 supplying drive voltages COM and SEG to the common electrode 25 and segment electrodes 14 to change the display color of the segments 5X. The rest period Tb is a standby period waiting for input of the next display switching signal after the display drive circuit 40 changes the time display, and the operating mode of the display drive circuit 40 is set to a power conservation mode during rest period Tb. The output nodes of the display drive circuit 40 for outputting drive voltages COM and SEG are set to a high impedance state during rest period Tb. A potential difference therefore does not occur between the common electrode 25 and segment electrodes 14 during rest period Tb, and the display color of the segments 5X remains the color that was set during redraw period Ta.

Changing the display color from white to blue and changing the display color from blue to white occur simultaneously during redraw period Ta in this embodiment of the invention. More specifically, the display drive circuit 40 applies a drive voltage SEG of a voltage corresponding to the display color (white or blue in this example) to be presented by a particular segment 5X to the segment electrode 14 of each segment 5X, and supplies a drive voltage COM of which the voltage changes over time according to the display color to the common electrode 25.

More specifically, as shown in FIG. 6, during the redraw period Ta of period (I) from time M1 to time M2, the display drive circuit 40 applies a +12V drive voltage SEG1 to the segment 5XA in order to change the display color to blue, and supplies a 0V (ground potential) drive voltage SEG2 to segment 5XB in order to change the display color to white. The drive voltage COM supplied by the display drive circuit 40 to the common electrode 25 during redraw period Ta varies over time between 0V to set the display color of the segment 5X to blue and +12V to set the display color to white.

Drive voltage COM in this embodiment of the invention is a comb pulse signal of which the voltage switches between +12V and 0V. The pulse width W of one pulse of the drive voltage COM is set to a frequency (such as 125 ms or 62.5 ms) that can be generated by frequency dividing a signal output from an oscillation circuit not shown, and the drive voltage COM can be generated based on this frequency division signal. A drive voltage COM of pulse train P that varies between +12V and 0V with a pulse width W is applied only so that the number of pulses required to change the display color of each segment 5X is applied (such as ten +12V pulses and ten 0V pulses). The reflectivity (brightness) and contrast of each segment 5X when the display color is changed can be adjusted by suitably adjusting this pulse count (redraw period Ta).

As a result, when the drive voltage COM is +12V during redraw period Ta, a potential difference is produced for pulse width W between the common electrode 25 and the segment electrode 14 of the segment 5XB to which a 0V drive voltage SEG2 is supplied, the blue particles 32 in the microcapsules 31 migrate to the segment electrode 14 side, the white electrophoretic dispersion fluid 33 moves to the common electrode 25 side, and the display color of the segment 5XB changes to slightly white. When the drive voltage COM then goes to 0V, a potential difference is produced for pulse width W between the common electrode 25 and the segment electrode 14 of the segment 5XA to which the +12V drive voltage SEG1 is applied, the blue particles 32 inside the microcapsules 31 are therefore pulled to the common electrode 25, and the display color of the segment 5XA changes to slightly blue. As this operation continues, the blue particles 32 gradually migrate to the common electrode 25 and segment electrode 14 according to the change in the drive voltage COM over time, the display colors of segments 5XA and 5XB gradually change, and at the end of redraw period Ta the display color of segment 5XA is blue and the display color of segment 5XB is white.

After redraw period Ta, the display drive circuit 40 waits for input of the next display switching signal, and when the next display switching signal is input at time M2, the display color of segments 5XA and 5XB is changed in redraw period Ta as described above. To reverse the display colors and change the display color of segment 5XA to white and the display color of segment 5XB to blue, for example, the display drive circuit 40 supplies a 0V drive voltage SEG1 to segment 5XA and supplies a +12V drive voltage SEG2 to segment 5XB, and supplies a comb pulse voltage COM that varies between +12V and 0V to the common electrode 25, in redraw period Ta.

All segments 5X thus change at the same time to the display color determined by the voltage of the drive voltage SEG applied to the corresponding segment electrode 14 within the redraw period Ta because the display drive circuit 40 thus applies a drive voltage SEG of a voltage determined by the color to be displayed by the segment 5X to the segment electrode 14 of the particular segment 5X, and applies a drive voltage COM that changes in time to the voltage corresponding to each display color during the redraw period Ta in which the time display is redrawn. First changing the display color of all segments 5X to the same color is thus not necessary to redraw the display, both white and blue can therefore be changed at the same time, and the display can therefore be redrawn more naturally.

Operation in the normal mode is described above.

Operation in the sleep mode is described next.

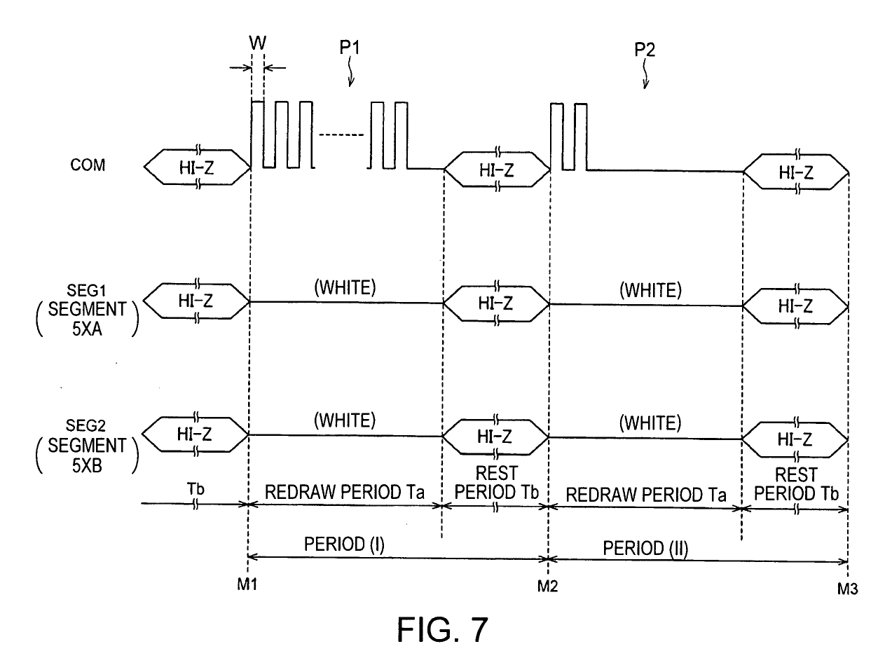

FIG. 7 is a timing chart of the display control operation when in the sleep mode. The time interval between the times M1, M2, M3 when the control circuit 57 outputs the display switching signal in the sleep mode, that is, the redraw interval of the display panel 5, is longer (such as 30 minutes) than the redraw interval (1 minute) in the normal mode. The redraw interval used in the sleep mode is not limited to this value, and may be set to 10 minutes or 1 hour, for example.

When entering the sleep mode the control circuit 57 first outputs a signal instructing the display drive circuit 40 to enter the sleep mode, thus causing the display drive circuit 40 to redraw the display area 5R (the addressable display area) of the display panel 5 to white. In order to redraw the display to white during the redraw period Ta of period (I) from time M1 to time M2, the display drive circuit 40 supplies a 0V (ground potential) drive voltage SEG to all segments 5X (only segment 5XA and segment SXB shown in this example), and applies the drive voltage COM needed to set the segments 5X to white to the common electrode 25 as shown in FIG. 7. The number of pulses in the pulse train P of the drive voltage COM is set to the number of pulses needed to set all segments 5X to the highest white contrast (such as 10 pulses), and the display area 5R of the display panel 5 can thus be changed to the same color.

Changing the display area 5R to the same color is not limited to setting all of the display area 5R to substantially the same hue, brightness, and chroma levels, and includes setting at least one of the hue, brightness, and chroma levels to the same level throughout the display area 5R.

After redraw period Ta, the display drive circuit 40 waits for input of the next display switching signal, and when the next display switching signal is input at time M2, the display drive circuit 40 supplies a 0V (ground potential) drive voltage SEG2 to all segments 5X in redraw period Ta in order to keep the display area 5R of the display panel 5 white, and applies the drive voltage COM required to hold white to the common electrode 25. The number of pulses in the pulse train P2 of the drive voltage COM is set to the number of pulses sufficient to hold the same display color, and in this embodiment of the invention is two pulses as shown in FIG. 7.

Each time M3 the display switching signal is thereafter input, the display drive circuit 40 continues to hold the entire display area 5R of the display panel 5 white in the same way as at time M2.

When the control circuit 57 then inputs a signal resetting the display drive circuit 40 to the normal mode, operation returns to the normal mode.

Operation in the sleep mode is described above.

This embodiment of the invention requires less power to redraw the display, and can therefore greatly reduce power consumption and extend the battery life, because the redraw interval is longer in the sleep mode than in the normal mode and the display can be redrawn using fewer drive voltage COM pulses in the sleep mode than in the normal mode.

As described above, this embodiment of the invention redraws the entire display area 5R of the display panel 5 when entering the sleep mode (reduced operation mode). As a result, when the normal mode is then resumed and a white and blue image is displayed on the display panel 5, color alignment problems are avoided even when using an electrophoretic display panel where the display color can be difficult to change after a certain display color has been displayed continuously for a long time.

Furthermore, because all of the display area 5R of the display panel 5 is redrawn to white at a predetermined period even during the sleep mode, misalignment of colors in the displayed image can be even more reliably avoided when the normal mode is resumed. As a result, a timepiece that enters a sleep mode to increase the redraw interval of the display panel 5 and assure sufficient battery life even when using a small battery with low capacity, and can display images without misalignment of the display colors on the display panel 5 when the normal mode is resumed, can be provided, and the timepiece can be easily rendered small.

Second Embodiment

A wristwatch 1 according to a second embodiment of the invention is identical to the wristwatch 1 of the first embodiment except that during the sleep mode the display area of the display panel 5 is redrawn to the same color in predetermined display area units. Like parts are identified by like reference numerals in this and the first embodiment, and further description thereof is omitted below where the differences between the embodiments are described.

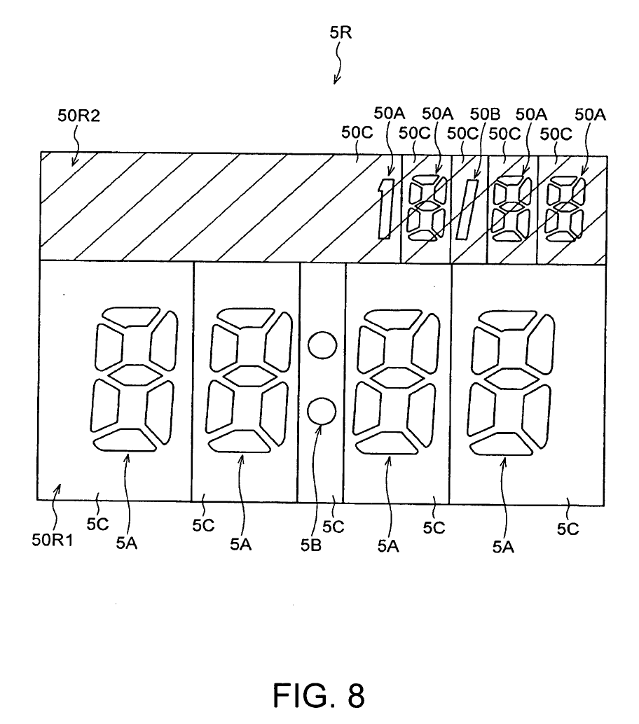

FIG. 8 shows the display panel 5 of a wristwatch 1 according to this second embodiment of the invention. The display area 5R of this display panel 5 comprises a time display area 50R1 for displaying the time, and a calendar display area 50R2 (the hatched area in the figure) for displaying calendar information.

The time display area 5OR1 comprises four segments (so-called “seven-segment displays”) 5A for displaying the numbers 0 to 9, a segment 5B for displaying a colon separating the hour and minute, and a background segment 5C for displaying a background in segments 5A and 5B.

The calendar display area 50R2 comprises four segments 50A for displaying the numbers 0 to 9, a segment 50B for displaying a character (a slash in this example) separating the month and day, and a background segment 50C for displaying a background in segments 50A and 50B.

In the normal mode, the display drive circuit 40 drives the background segment 5C to display white and selectively drives segments 5A and 5B to display blue and white to show the current time in time display area 5OR1 of display panel 5, and drives the background segment 50C in calendar display area 50R2 to display blue, and selectively drives segments 50A and 50B blue and white to display the current date (month and day). As a result, the current hour and minute are displayed with blue numbers on a white background, and the current month and day are displayed with white numbers on a blue background.

In this embodiment of the invention the timekeeping circuit 51 has a function for keeping the time and calendar, and the display drive circuit 40 gets the timekeeping result from the timekeeping circuit 51 and drives redrawing the display panel 5 at one minute intervals to update the displayed time to the time one minute later at the update timing of the current time, and updates the displayed date to the date one day later at the calendar update timing (such as at 12:00 a.m.) When a command to enter the sleep mode is input from the control circuit 57, the display drive circuit 40 redraws all of the time display area 50R1 set in a predetermined first display area to display white, and redraws all of the calendar display area 50R2 set in a predetermined second display area to display blue.

At the same redraw interval described in the first embodiment, that is, at a longer redraw interval than the redraw interval (one minute) of the normal mode, the display state is then redrawn in order to hold the same display state. As in the first embodiment, the number of pulses in the pulse train P2 of the drive voltage COM applied to hold the display state is fewer (such as two pulses) than the number of pulses applied in the normal mode. When a command to resume the normal mode is then input from the control circuit 57, the display drive circuit 40 resumes operating in the normal mode.

This embodiment of the invention thus avoids color misalignment within time display areas 50R1 and 50R2 by redrawing the display area delineated by the background segments 5C that display white during the normal mode, that is, all of time display area 50R1, to white when entering the sleep mode, and redrawing the display area delineated by background segments 50C that display blue during the normal mode, that is all of the calendar display area 50R2, to blue. The problem of the borders between adjacent display areas delineated by background segments 5C and 50C in the time display areas 50R1 and 50R2 becoming conspicuous due to color misalignment can thus be reliably avoided.

Furthermore, because the display areas 50R1 and 50R2 are redrawn when entering the sleep mode to the same color that is expected to be displayed when the normal mode is resumed, the color (crisp white and blue, for example) scheduled for display in the background segments 5C and 50C of the display areas 50R1 and 50R2 when the normal mode is resumed can be accurately displayed.

It will be obvious to one with ordinary skill in the related art that this embodiment of the invention is just one example of the present invention, and the invention can be varied in many ways without departing from the scope of the accompanying claims. For example, the predetermined display areas of the display panel 5 are redrawn to white or blue when the sleep mode is entered in these embodiments of the invention, but an intermediate color can be displayed or a gray scale image of substantially the same color can be displayed. More particularly, the display can be redrawn to any display image, specifically any display image with little color variation, that can suppress color misalignment when the normal mode is resumed.

These embodiments are also described with the predetermined display areas set to the entire display area of the display panel 5, the time display area, or the calendar display area, but the invention is not so limited. More particularly, the predetermined display areas can be only a part of the display area on the display panel 5. For example, the predetermined display area can be only the part of the display area where a pattern is continuously displayed in the normal mode.

Furthermore, when more than one image or type of information is displayed on the display panel 5, the information or images are generally displayed in display area units delineated by the background segments, and the predetermined display areas are therefore preferably set according to the display area units delineated by the background segments.

These embodiments are also described as redrawing the display in the sleep mode in order to retain the display color of the display panel 5, but the invention is not so limited and redrawing the display panel 5 in the sleep mode can be omitted.

A one-particle electrophoretic display panel is used as the display panel 5 having an image retention characteristic in this embodiment of the invention, but the invention is not so limited and a two-particle electrophoretic display panel can be used, for example. The display method is also not limited to a segment display, and a dot matrix display could be used instead.

This embodiment of the invention is described using a wristwatch by way of example, but the invention is not so limited and can be applied to a wide range of electronic devices and display devices comprising an electrophoretic display panel. For example, the invention can be used with a mantle clock, a wall clock or grandmother clock, a pocket watch, or other type of timepiece, personal digital assistants (PDA), cell phones, printers, scanners, and notebook computers. When rendered as a portable device such as a timepiece, the invention is also not limited to wristwatches, and can be adapted to various other shapes, including necklaces, rings, and pendants.

The entire disclosure of Japanese Patent Application No. 2005-226774, filed Aug. 4, 2005.

What is claimed is:

1. A display device comprising:
an electrophoretic display panel for displaying information; and
an operating mode switching unit for changing between a normal mode in which information displayed on the electrophoretic display panel is redrawn at a predetermined redraw interval, and a reduced operation mode in which redrawing the electrophoretic display panel is stopped or the redraw interval is increased;
wherein the operating mode switching unit redraws a predetermined display area of the electrophoretic display panel to substantially the same color when changing to the reduced operation mode.

2. The display device described in claim 1, wherein the predetermined display area is the entire display area of the electrophoretic display panel, or is a display area where an image of substantially the same color is displayed when entering the normal mode.

3. The display device described in claim 1, wherein:
the electrophoretic display panel is a segment display panel; and
when entering the reduced operation mode, the operating mode switching unit redraws a portion of the display area of the electrophoretic display panel to substantially the same color in display area units delineated by segments for displaying a background.

4. The display device described in claim 1, wherein when entering the reduced operation mode the operating mode switching unit redraws the predetermined display area to substantially the same color as the color to be displayed when the normal mode is entered.

5. The display device described in claim 1, wherein when entering the reduced operation mode the operating mode switching unit displays a substantially monochrome gradation image in the predetermined display area.

6. The display device described in claim 1, wherein when entering the reduced operation mode the operating mode switching unit redraws the predetermined display area so that at least one of the hue, brightness, and chroma levels is substantially the same.

7. The display device described in claim 1, wherein the display device is rendered as a timepiece having a timekeeping unit for keeping time and displays time information kept by the timekeeping unit.

8. A control method for a display device having an electrophoretic display panel and displaying information on the electrophoretic display panel, the control method comprising a step of:
redrawing a predetermined display area of the electrophoretic display panel to substantially the same color when changing from a normal mode in which information displayed on the electrophoretic display panel is redrawn at a predetermined redraw interval to a reduced operation mode in which redrawing the electrophoretic display panel is stopped or the redraw interval is increased.

9. The display device control method described in claim 8, wherein when entering the reduced operation mode, a portion of the display area of the electrophoretic display panel is redrawn to substantially the same color in display area units delineated by segments for displaying a background.

10. The display device control method described in claim 8, wherein when entering the reduced operation mode the predetermined display area is redrawn to substantially the same color as the color to be displayed when the normal mode is entered.

11. The display device control method described in claim 8, wherein when entering the reduced operation mode a substantially monochrome gradation image is displayed in the predetermined display area.

12. The display device control method described in claim 8, wherein when entering the reduced operation mode the predetermined display area is redrawn so that at least one of the hue, brightness, and chroma levels is substantially the same.
